(19) United States
(12) Patent Application Publication
(10) Pub. No.: US 2015/0140518 A1
(43) Pub. Date: May 21, 2015

(54) TRAINING DEVICE

(71) Applicant: TERESA ANN HORNING, Shelby Township, MI (US)

(72) Inventor: TERESA ANN HORNING, Shelby Township, MI (US)

(21) Appl. No.: 14/082,029

(22) Filed: Nov. 15, 2013

(51) Int. Cl. F41J 7/00; F41J 1/10; G09B 9/00

(52) U.S. Cl. CPC F41J 7/00; G09B 9/003; F41J 1/10
USPC 434/19; 434/11

(57) ABSTRACT

Disclosed is a portable target training device that offers a versatile means of conducting target training, which may be adapted for use on varying terrain, outdoors, indoors, in scenario training, and in conjunction with accessories that affect both the exterior and interior conditions of the training device. The present invention houses a plurality of targets and/or obstacles that may be positioned in a manner that suits users' requirements. Users may adapt the training device and its interior targets for use in and on a wide variety of terrain, outdoors, indoors, in various scenarios, and with accessories that artificially simulate various environmental conditions. Various types of training may be performed within the training device, including, but not limited to, Percussion, traditional or nontraditional weapons, non-live round firearms training, martial arts training, melee weapon training, and mock firearm training.

### CLAIM OF PRIORITY

This Application hereby claims the benefit of U.S. Provisional Application No. 61727171, which was filed on Nov. 16, 2013, having confirmation number 4202.

### FIELD OF THE INVENTION

The present invention relates generally to target-based combat training. More specifically, the present invention is a training device that houses one or more targets and or obstacles and or visual and or audible stimuli. The training device is versatile in that it may be adapted for use on varying terrain, outdoors, indoors, in scenario training, and in conjunction with accessories that affect both the exterior and interior conditions of the training device. Various types of training may be performed within the training device including, but not limited to, (percussion, traditional or nontraditional weapons, non-live round firearms training such as, but not limited to airsoft, nerf, or paintball) martial arts training, melee weapon training, and mock firearm training.

The present invention also relates to a portable virtual training or advertising experience device. More specifically, the present invention can be adapted for use with video and audio equipment for a fully automated training or advertising experience.

### BACKGROUND OF THE INVENTION

Targets are often used as part of the regimens for martial arts, melee weapons, and firearms training. Training is often conducted in groups with trainees subject to various environmental or situational conditions. (at times environmental factors are incorporated, but for the average practitioner environmental factors are controlled) These conditions include, but are not limited to, factors such as weather, terrain, and obstacles that are all designed to introduce trainees to likely real-world situations.

A deficiency in the current art related to target-based combat training is lack of movement. Current training methods are limited generally to stationary targets, stationary obstacles, and stationary trainees. In live combat situation, it is exceedingly rare for one to get an opportunity to strike or shoot at a stationary target. Yet that is how most target-based training is done. As well, there is a need for a training system that is portable, and adaptable to various weather and terrain conditions.

### SUMMARY OF INVENTION

The present invention fills the needs described above. It seeks to offer a versatile device and method of conducting target-based training that users may adapt to suit their needs. The device is portable and training is adaptable for use with moving targets, moving obstacles, and the trainee themselves may be moving. The device of the present invention houses one or more targets that may be positioned in a manner that suits users' requirements. Users may adapt the training device and its interior targets for use in and on a wide variety of terrain, outdoors, indoors, in various scenarios, and with accessories that artificially simulate various environmental conditions. The present invention is capable of shielding trainees from the elements while also providing the option of subjecting the trainees to the elements as a part of the training. The training device is selectively assembled and encompasses a wide range of shapes and sizes in order to accommodate user needs and space restrictions. In its preferred embodiment, the present invention comprises a plurality of supporting structural elements onto which targets or equipment are placed. Users are provided the option of partially or fully concealing the interior of the training device with a cover.

The present invention offers a high level of versatility in terms of training environments and scenarios. The versatility stems from the various accessories that may be integrated into the training device to simulate environmental factors as well as simulated scenarios. Further versatility is provided by the ability of the present invention to be adapted for use in virtually any environment and terrain. Examples of accessories include, but are not limited to, smoke generators, mist generators, speakers, cameras, lasers, lights, and obstacles.

### BRIEF DESCRIPTION OF THE DRAWINGS

FIG. 1 is an isometric view of four cylindrical base beams with rubberized, non-marking capped feet

FIG. 2 is an isometric view of a plurality of base beams connected together to form a frame for the training device

FIG. 3 is an isometric view of a plurality of base beams as well as a plurality of targets connected to the base beams

FIG. 4 is an isometric view of the assembled training device

FIG. 5 is an isometric view of an alternate embodiment of the base beams of the training device

FIG. 6 is an isometric view of an alternate base of the training device with targets attached

FIG. 7 is an isometric view of the assembled training device with cover tarp attached and training device fully covered

FIG. 8 is an isometric view of the assembled training device with cover tarp attached and open to the exterior environment

### DETAIL DESCRIPTIONS OF THE INVENTION

All illustrations of the drawings are for the purpose of describing selected versions of the present invention and are not intended to limit the scope of the present invention.

Applicant has provided reference numerals to assist with understanding the invention. The reference numerals correspond to elements of the invention as follows:

1. Portable Target Training Device

2. A Scaffolding

3. One Or More Targets

4. A Removable Ventilated Cover

5. A Plurality of Base Beams

6. A Plurality of Structural Beams

7. A Plurality of Connecting Members

8. A Foundation

9. A Mist Generator

10. A Smoke Generator

11. One or More Speakers

12. One or More Lasers

13. One or More Lights

14. One or More Obstacles

15. A Visual Display

16. A Control System

17. One or more cords

18. One or more doors in the cover

19. One or more holes for cover ventilation

20. Feet for the structural beams

The present invention is a training device 1 that is configurable to subject trainees to a wide variety of environmental conditions and other scenarios. In its preferred embodiment, the present invention comprises a plurality of base beams 5, a plurality of structural beams 6 and connecting members 7, a plurality of targets 3, and a cover 4. The present invention is not limited with respect to shape and size of the training device as users may set up the training device 1 according to their desired training conditions.

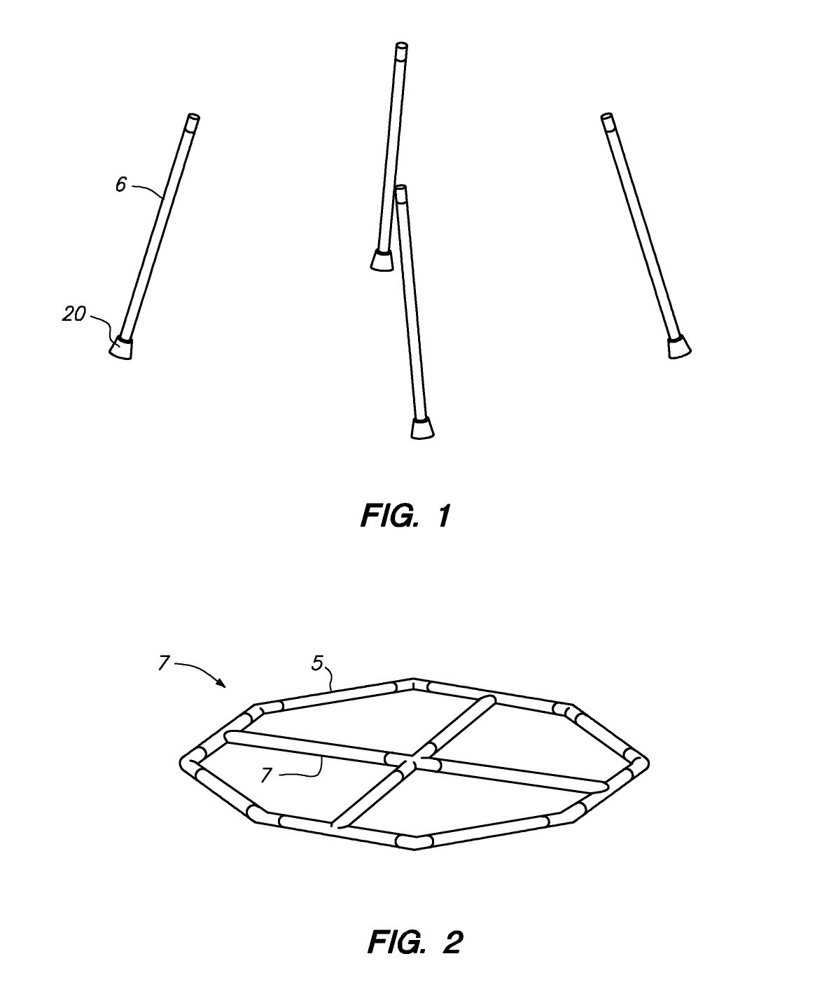

With respect to FIG. 1, in the preferred embodiment of the present invention, a base beam 5 comprises a structural element 6. The structural element 6 of a base beam 5 is an extruded member with a first end and a second end. The base beam 5 is not limited with respect to shape and size of the beam 5 itself or with respect to the cross-sectional shape of the beam 5. However, in the preferred/present embodiment of the present invention, the base beam 5 comprises a cylindrical extrusion of material with circular cross-section. One end of the base beam 5 may be capped by a non-marking, rubberized material for extra security for the present invention on a surface. In the preferred embodiment of the present invention, the base beams 5 form the foundation of the training device 1 and are connected to the structural beams 6 forming the body of the training device 1. The present invention 1 is not limited with respect to arrangement or design of the base beams 5. For example, base beams 5 may be utilized as support legs for the structural beams 6. Alternatively, the base beams 5 may be joined together to form a structural base to 6 which the structural beams 5 may be connected.

Referring to FIG. 2, in the preferred embodiment of the present invention 1, a structural beam 6 comprises a structural element, similar to a base beam 5. The structural element 6 of a structural beam 5 is likewise an extruded member that is not limited with respect to shape, size, and cross-sectional shape. Structural beams 6 form the main body of the training device 1 and serve as a support for targets 3 to be attached to the training device 1. The structural beams 6 are able to be secured to one another by means of connecting members 7. A connecting member 7 comprises an extruded member with a first end and a second end. The first end and second end are shaped and sized in a manner such that they are able to accommodate and secure structural beams 6. Each structural beam 6 further comprises a first end and a second end. Structural beams 6 are connected to one another by inserting the first or second end of a structural beam 6 into the first end or second end of a connecting member 7. A second structural beam 6 is inserted into the remaining open end of the connecting member 7 to secure the two structural beams 6 together. Although the preferred embodiment of the present invention features connecting members 7 for securing structural beams 6, alternative embodiments of the present invention 1 may feature interlocking structural beams 6 that are connected directly to each other. The present invention is not limited with respect to methods of attachment for the structural beams 6.

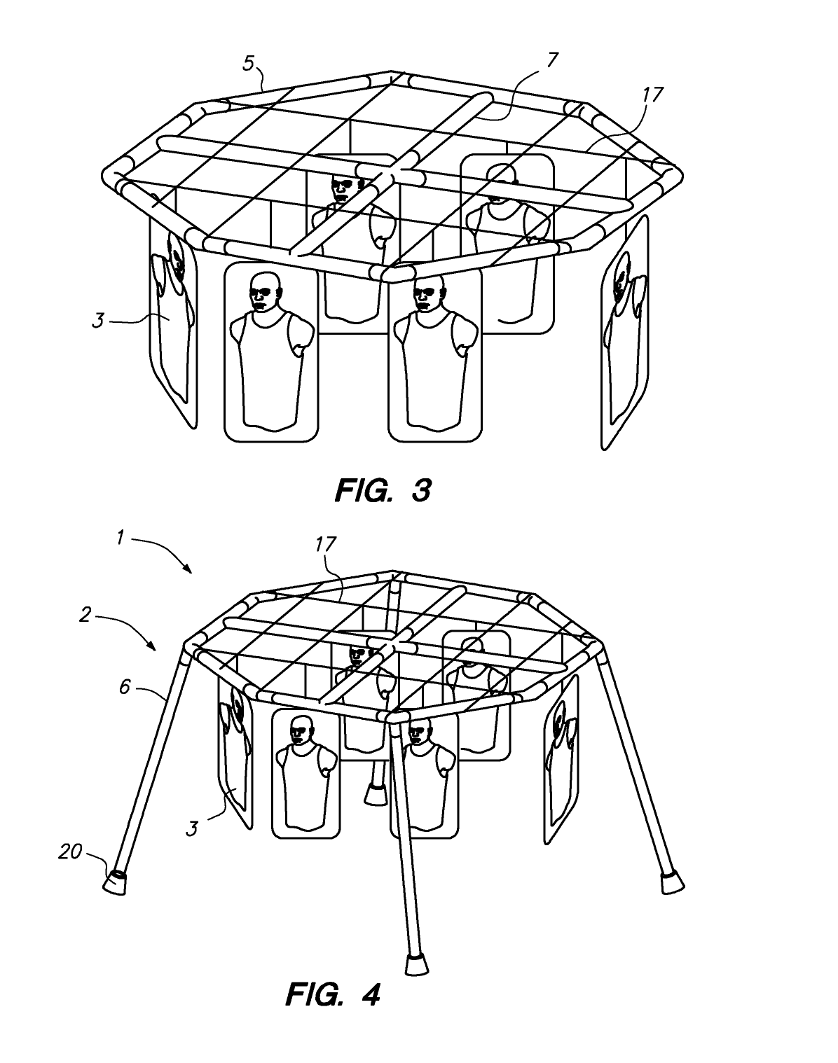

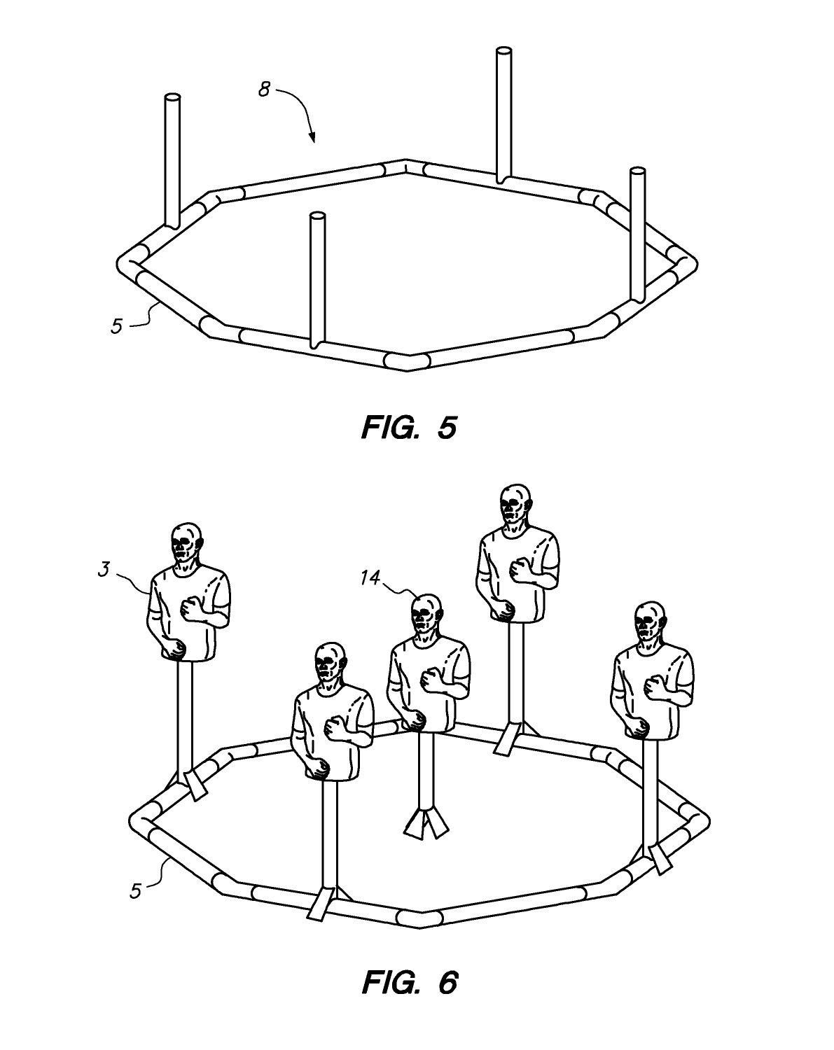

With reference to FIG. 3, FIG. 4, and FIG. 6, the training device 1 of the preferred embodiment of the present invention incorporates a plurality of targets 3. Targets 3 are not limited with respect to size, shape, and any other factors regarding the physical appearance of the targets 3. As the present invention is versatile in order to accommodate various training regimens, the training targets 3 reflect this diversity. Examples of training targets 3 to be used with the present invention include, but are not limited to, mannequins, flat paper targets, and bamboo sword targets. In the preferred embodiment of the present invention 1, targets 3 are secured to the structural beams 6 of the training device 1. However, the targets 3 are not limited with respect to means of attachment to the structural beams 6 or with respect to locations of attachment. Additionally, targets 3 are not limited with respect to mobility. Targets 3 within the training device 1 may be immobile or subject to movement.

The present invention 1 further comprises a removable cover 4. In the preferred embodiment of the present invention 1, the cover 4 comprises a sheet of flexible material. The sheet of material is flexible and sturdy in order to allow movement and to serve as a barrier for containing projectiles within the training device 1. The cover 4 also provides reasonable protection from the elements to trainees within the training device 1. The cover 4 may also be used to expose trainees to the elements as a part of training regimens.

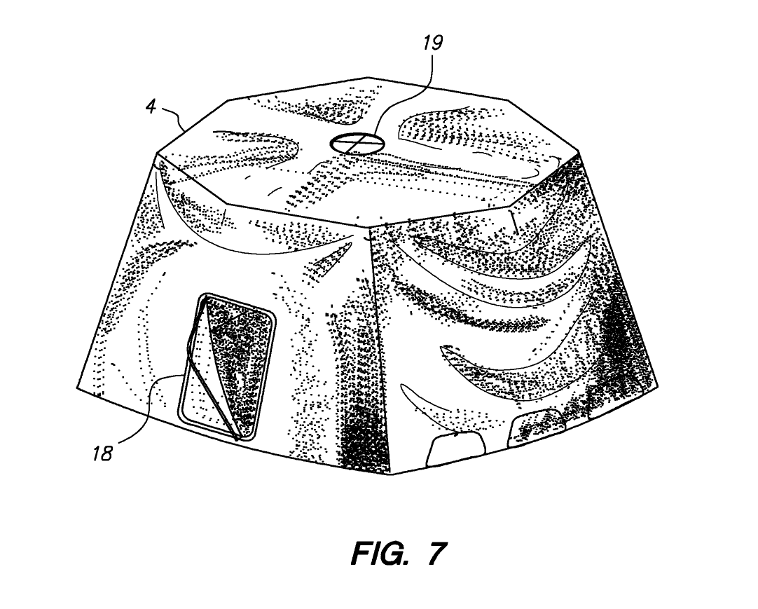

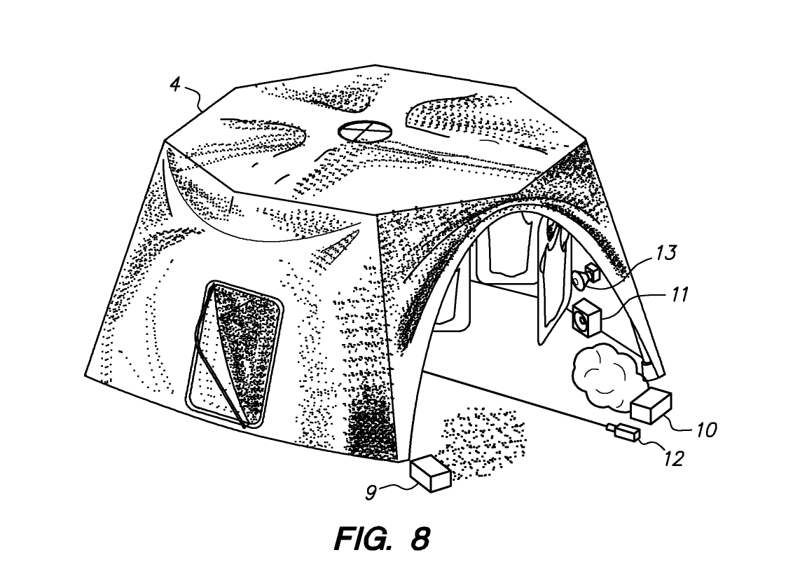

An example of exposure to the elements is the One or more sections of removed material forming openings 18 are present on the cover 4 as well. In the preferred embodiment of the present invention 1, one or more covers 4 may be deployed on the training device 1. A secondary cover (not shown) may be built into a primary cover 4 as well to provide additional protection from heat and sunlight. The present invention 1 may be utilized without a cover 4 as shown in FIG. 4 and FIG. 6. All covers 4 are adjustable in order to partially or fully expose the inner training area of the present invention 1 as shown in FIG. 7 and FIG. 8. Covers 4 are not limited with respect to their attachment method to the training device 1. The covers 4 may be draped onto the structural elements 6 of the training device 1 or they may be secured by means including, but not limited to, stakes driven into the ground. To provide additional security for the training device 1 on a surface, anchoring weights or stakes may be placed to secure or stabilize. Anchoring weight may be placed upon the foundation 8. A parachute cord may be used to secure the cover 4 with stakes. The versatility of the present invention 1 stems from the various accessories that may be used in conjunction with the training device 1 to simulate environmental situations and scenarios. Examples of accessories include, but are not limited to, smoke generators 10, mist generators 9, speakers 11, cameras (not pictured), projectors (not pictured), lasers 12, lights 13, and obstacles 14. These accessories 9-14 are utilized to generate effects in both the interior and exterior of the training device 1. The individual components of the present invention 1 are capable of working in synergy with the external accessories 9-14 to subject trainees to various environmental conditions and scenarios. For example, a visual display 15 may be projected onto the removable cover of the training device 1. Similarly, projected targets 3 may be used in addition to the physical targets 3 present within the training device 1. Trainees may also be subject to interactive feedback from the training device 1 based on their actions during a training session. Effects and feedback may be automated based on trainee actions within the training device 1 or they may be managed via an external control system 16. An example of interactive feedback is a target turning to face a trainee based on the trainee's movement.

The versatility of the present invention 1 is further demonstrated through the ability to use the present invention 1 in virtually any environmental conditions or terrain, within reason. The present invention 1 is designed for use both indoors and outdoors. The present invention is also adaptable in order to subject trainees to the various elements found outdoors as shown in the example of FIG. 8. The present invention may be used on a wide range of terrain including, but not limited to, rocky terrain, flat terrain, curved terrain, sloped terrain, and wet terrain. This allows the present invention 1 to take advantage of already present terrain and incorporate any factors presented by said terrain into a training session.

In the preferred embodiment of the present invention, multiple training devices may be connected together. These larger training devices may be covered by large covers 4 designed for use with larger training devices. Alternatively, multiple smaller coverings may be used in conjunction with the larger training devices.

In addition to connecting multiple training devices 1 to form larger training devices 1, the training areas within the devices 1 may be separated into smaller individual sections. The divisions can be formed by any means including, but not limited to, hanging removable walls from structural beams 6, cord or wire and placing obstacles 14 inside the training devices 1 to section off individual areas.

The present invention also includes a method of target-based combat training utilizing the device described herein. The method may comprise the steps of: providing the device of claim 1; challenging the trainee to strike the plurality of targets of the device in a predetermined manner; presenting the trainee with one or more obstacles, the obstacles being selected based on a training need of the trainee; providing interactive feedback to the trainee.

The obstacles may include of smoke, mist, lasers, walls, boxes, people, terrain, weather, lights, and sound. As well, the trainee may be forced to adapt to an unknown challenge. The method is useful for target-based combat training in the areas of firearms training using non-live weapons and ammunition, martial arts training, percussion training, traditional weapons training, non-traditional weapons training, and more.

Although the present invention 1 has been explained in relation to its preferred embodiment, it is to be understood that many other possible modifications and variations can be made without departing from the spirit and scope of the present invention.

What is claimed is:

1. A portable target training device comprising:
a. a supporting framework;
b. one or more targets;
c. a removable ventilated cover made of a flexible material;
d. wherein:
i. targets are coupled removably to the scaffolding;
ii. the removable cover is coupled to the scaffolding.
iii. the targets are adapted to change position upon being struck by an instrumentality.

2. The device of claim 1, wherein the supporting framework comprises:
a. a plurality of base beams;
b. a plurality of structural beams;
c. a plurality of connecting members;
d. wherein:
i. the base beams are interconnected via the connecting members forming a foundation;
ii. the foundation is connected to the structural beams via the connecting members forming a body of the training device;

3. The device of claim 2, further comprising a plurality of feet disposed on an end of the structural beams.

4. The device of claim 1, further comprising one or more cords strung upon the scaffolding, wherein the targets and one or more obstacles are hung from the cords.

5. The device of claim 1, wherein the targets are selected from the group consisting of bamboo mats, flat paper targets, percussion targets, projected targets, movable walls, and mannequins.

6. The device of claim 1, further comprising a mist generator coupled to the device.

7. The device of claim 1, further comprising one or more speakers coupled to the device.

8. The device of claim 1, further comprising one or more lasers coupled to the device.

9. The device of claim 1, further comprising one or more lights coupled to the device.

10. The device of claim 1, further comprising a smoke generator coupled to the device.

11. The device of claim 1, further comprising one or more obstacles positioned to make striking the targets more difficult.

12. The device of claim 1, further comprising a visual display coupled to the device.

13. The device of claim 1, wherein the targets are adapted to move about the body of the device.

14. The device of claim 1, further comprising a control system capable of remotely manipulating the targets and interactive feedback is provided to a trainee via the control system.

15. The device of claim 1, wherein the supporting framework is flexible thereby allowing the device to function in varying weather conditions and on varying terrain.

16. The device of claim 1 further comprising a second removable ventilated cover placed upon the first removable ventilated cover to reflect heat and maintain a comfortable temperature inside the device.

17. The device of claim 1, wherein the device is divided into two or more sections by one or more removable walls, the removable walls being hung from the supporting framework.

18. The device of claim 1, wherein the cover includes one or more doors to allow for entry and exit of the device.

19. The device of claim 1, wherein the removable cover is placed so that half of the supporting framework is covered.

20. A method of providing target-based combat training to a trainee comprising the steps of:
a. providing the device of claim 1;
b. challenging the trainee to strike the plurality of targets of the device in a predetermined manner;
c. presenting the trainee with one or more obstacles, the obstacles being selected based on a training need of the trainee;
d. providing interactive feedback to the trainee.

21. The method of claim 20, wherein the obstacles are selected from the group consisting of smoke, mist, lasers, walls, boxes, people, terrain, weather, lights, and sound;

22. The method of claim 20, further comprising the step of forcing the trainee to adapt to an unknown challenge.

23. The method of claim 20, wherein the target-based combat training is selected from the group consisting of firearms training using non-live weapons and ammunition, martial arts training, percussion training, non-traditional weapons training, and traditional weapons training.

24. The method of claim 20, further comprising the step of providing a second device, the second device being as in claim 1, wherein the trainee passes from the first device to the second device during the target-based combat training.
